(19) United States
(12) Patent Application Publication
(10) Pub. No.: US 2017/0231870 A1
(43) Pub. Date: Aug. 17, 2017

(54) Medication Dispensing Device

(71) Applicant: IMED MD, LLC, Waynesville, OH (US)

(72) Inventors: Adam Stachler, Waynesville, OH (US); Cynthia Leaton, Moscow, OH (US)

(73) Assignee: IMED MD, LLC, Waynesville, OH (US)

(21) Appl. No.: 15/417,310

(22) Filed: Jan. 27, 2017

Related U.S. Application Data
(60) Provisional application No. 62/293,888, filed on Feb. 11, 2016.

(51) Int. Cl. A61J 7/00; B65D 83/04

(52) U.S. Cl. CPC A61J 7/0076; B65D 83/0481; A61J 2205/70; A61J 2200/30

(57) ABSTRACT

A medication storage and dispensing device having a biometric sensor to restrict access to the medication stored within. The device is locked to prevent access and includes tamper resistance features to prevent unauthorized access to the medication stored within. The device has wireless connection features that allow monitoring by medical professionals.

### CROSS-REFERENCE TO RELATED APPLICATION

This application is a nonprovisional application and claims the right of priority to U.S. Patent Application No. 62/293,888 filed on Feb. 11, 2016 and incorporates the same as if fully rewritten herein.

### TECHNICAL FIELD

Exemplary embodiments of the present invention are directed to a medical dispensing device. More particularly, exemplary embodiments of the present invention relate to a securely locked and tamperproof medical dispensing device and a system of using said inventive medical dispensing device.

### BACKGROUND OF THE ART

In 2010, pharmaceutical companies generated 8 billion dollars in revenue from the sale of opioids. The global market has continued to increase and is projected to reach 13.2 billion dollars globally in 2017. As the number of prescriptions increase, the opportunity for abuse and diversion also increase.

This increased availability of prescription pain relievers has resulted in more deaths than some controlled substances. In 2014 there were 18,893 overdose deaths related to prescription pain relievers and 10,574 overdose deaths related to heroin. Additionally, in 2014, 467,000 adolescents were current nonmedical users of opioid pain relievers. 44 people die everyday in the United States due to prescription painkiller overdose and in 2013 there were 2 million people that abused prescription pain relievers. The illegal use of prescription opioids now exceeds use of street narcotics in the United States.

Another major concern is that the patient needing the pain relievers may not be the abuser. Studies have shown that 56.5% of nonmedical use of prescription opioids came from a friend or relative of the patient. Additionally, in 2007, diversion was a factor in over 50% of the overdose fatalities. Opioid abuse not only has an impact on the lives of the nonmedical abusers, but also represents a significant financial burden. The average direct health care costs for patients who abuse opioids are 8.7 times higher than non-abusers.

Opioids are not the only prescription drug being abused. Prescription stimulants are also being abused. In 2011, there were 48.4 million ADD/ADHD stimulant prescriptions issued in the United States. This represents a 29% increase from 2007. This increased access has results in 13% of teens reporting that they have taken prescription stimulants, such as Ritalin or Adderall, that were not prescribed for them. Moreover, the most common source of prescription stimulants for college students was a friend with a legitimate prescription. Accordingly, there is a need for an easy to use device and method to prevent medication abuse and diversion.

### SUMMARY OF THE INVENTIVE CONCEPT

The inventive medical dispensing system disclosed herein prevents abuse and diversion of controlled medication while also providing feedback to medical professionals regarding, pain management issues and patient schedule compliance. The inventive medical dispensing device includes a top lid and a base. The top lid has a domed shape and an indent that allows for the placement of a biometric scanner. The biometric scanner is used to ensure that only the patient has access to the medication stored with the device. The top lid may also include a screen to display messages to the patient such as the appropriate time to take the medication, or warning such as too many pills have been dispensed and the medical professional has been notified. Similarly, the device may have speakers to provide audible alerts to the patient.

The top lid may be securely fastened to the base. Locks may also be employed to ensure that the top lid remains attached to the base, as well as providing a way to monitor if someone is attempting to tamper with the device. The base is cylindrical having an open top. The interior of the base has supports for attachment of a dispensing plate. The dispensing plate has a retention portion and a dispensing portion. The dispensing portion is angled downward relative to the retention portion so that dispensed medication is moved toward a dispensing opening in the base. The retention portion also has retention guides extending therefrom for securing prescription bottles thereto.

To allow medication to be dispensed from standard prescription bottles an inventive cap is used in the device. The cap is attached to a standard prescription bottle and allows medication to be released. The cap includes an outer cap and a dispensing insert. The dispensing insert is rotatably attached to the outer cap. The outer cap and the dispensing insert both include a dispensing port, when the dispensing ports are aligned medication is allowed to drop from the prescription bottle. To assist with this the dispensing insert has a concave face directing the medication within the prescription bottle toward the dispensing port. The outer cap also has guide projections that are inserted into channels in the retention guides on the dispensing plate to secure the cap into the retention guide and prevent the outer cap from rotating relative to the retention guide. Optionally, the inventive cap may include a size selection insert. The size selection insert, if used, is placed between the outer cap and the dispensing insert. The size selection insert has a circular body and several punch-outs therein. The punch-outs are pre-scored or molded such that they are capable of being removed from the size selection insert. The punch-outs have varying diameters so that a pharmacist or medical professional may select the proper size for the medication being used. Once a size is selected, the proper punch-out is removed creating a sized dispensing port. The size selection insert also has tabs around its circumference. These tabs are used to secure the size selection insert in the outer cap and prevent rotation between the outer cap and the size selection insert. Specifically, the outer cap has channels in its interior that are adapted to receive the tabs on the size selection insert. The size selection insert is placed in the outer cap so that the sized dispensing port is aligned with the dispensing port in the outer cap.

A control circuit, located within the base of the device, controls the electronic components of the device, including the biometric scanner, screens, and speakers. The control circuit also has an associated memory. Although, many types of control circuits are contemplated, a printed circuit board may be used. In order to operate the inventive cap, an electric motor is located in the base of the device. The electric motor is positioned to interact with the cap once the cap has been properly placed in the retention guides. The electric motor has a post that extends above the dispensing plate. This post is in communication with a pin on the cap. When the control circuit directs the electric motor, it spins the post which in turn spins the pin and turns the dispensing insert until the dispensing port in the dispensing insert aligns with the dispensing port in the outer cap allowing medication to exit the prescription bottle.

Once the medication exits the prescription bottle it is directed to the dispensing opening in the base by the dispensing portion of the dispensing plate. To ensure that the mediation is directed to the dispensing opening in the base, the dispensing portion has rails extending from the surface of the dispensing portion forming a channel for the medication to travel in. To ensure that the proper amount of medication is dispensed sensors may be present in the device. The sensors are in electronic communication with the control circuit and are used to not only to determine the amount of medication that is dispensed, but to also monitor whether someone is attempting to tamper with the device.

To allow monitoring of the device, the control circuit may also have a communication module in electronic communication. This communication module provides wireless or wired communication. The types of wireless communication provided by the communication module includes, but is not limited to, cellular, Bluetooth, wi-fi, and radio. This connectivity allows for monitoring of the device and tampering by medical professionals or the pharmacist.

The device may also be used with web based programs and mobile applications. The communication module allows the device to communicate directly with the web based program, it can communicate through text messaging or directly to a mobile application. This allows the device to easily provide the medication schedule to the patient and allows for monitoring by the medical professional.

To dispense the medication, the patient's or the patient's caregiver's fingerprints are scanned and saved either in the memory of the device or the on the web based program. The patient's medication schedule is also saved on the device. Once the prescription is filled and the patient takes the device home, the device will send an alert to the patient that it is time to take the medication. The alert can be audible, visual, and the device may send a notification to the patient's cellphone. The patient then has a predetermined amount of time to access the medication. To access the medication, the patient or the patient's caregiver scans there fingerprint using the biometric scanner on the device. If the scanned fingerprint matches the stored fingerprint, the control circuit activates the electric motor, which in turn positions the inventive cap to dispense medication. Once the medication is dispensed, the sensors check to determine if the proper amount of medication has been dispensed. If the proper amount of medication has been dispensed then the medication is allowed to exit the device for the patient's use. The dispensing of the medication is then logged by the device and may be stored in memory and/or communicated to the web based program or mobile application. By requiring the fingerprint of the patient or the patient's caregiver the device helps to reduce diversion of the patient's medication.

The device also assists with tampering. The locks and sensors are able to detect if an individual is attempting to gain access to the medication stored in the device. If tampering is detected the device may immediately send a notification to the pharmacist or the medical professional either directly or to the web based program or mobile application. The device may also include features that could render the medication inert. The device may include a spray nozzle in communication with the control circuit. Once tampering is detected the control circuit may direct the spray nozzle in the device to release a chemical that renders the medication inactive. This feature may also be used if too much medication exits the prescription bottles. The device may also emit an audible alarm if it detects tampering to notify the patient that someone is attempting to access the medication.

The device also allows for monitoring of the patient reactions and pain information. The mobile application used by the patient may allow the patient to input pain information. The medical professional would have access to this information and it may be used to adjust the patient's medication schedule. If the medical professional wishes to change the patients medication schedule it may be done through the web based program eliminating the need for the patient to visit the pharmacist or the medical professional.

### BRIEF DESCRIPTION OF THE DRAWINGS

The advantages and other characteristics of the disclosed embodiments will be better understood when attention is directed to the accompanying drawings, wherein identical elements are identified with identical reference numerals and wherein:

FIG. 1 is a top perspective view of an exemplary embodiment of the present invention;

FIG. 2 is an exploded view of an exemplary embodiment of the present invention;

FIG. 3 is a perspective view of the base of the inventive medical dispensing device of FIG. 1;

FIG. 4 is a perspective view of the dispensing plate of the inventive dispensing device of FIG. 1;

FIG. 5 is a side view of the dispensing plate of the inventive dispensing device of FIG. 1;

FIG. 6 is a perspective view of the outer cap of the inventive dispensing device of FIG. 1;

FIG. 7 is a perspective view of the dispensing insert of the inventive dispensing device of FIG. 1;

FIG. 8 is a perspective view of an exemplary embodiment of a size selection insert for use with the device of FIG. 1;

FIG. 9 is an exploded view of an exemplary embodiment of a cap for use with the device of FIG. 1;

FIG. 10 is a bottom perspective view of the exemplary size selection insert and an exemplary embodiment of an outer cap for use with the device of FIG. 1;

FIG. 11 is a bottom perspective view of the exemplary size selection insert and an exemplary embodiment of an outer cap for use with the device of FIG. 1;

FIG. 12 is a bottom perspective view of the exemplary size selection insert and an exemplary embodiment of an outer cap for use with the device of FIG. 1;

FIG. 13 is a perspective view of an exemplary embodiment of a pill measuring device to be used with the inventive device described herein;

FIG. 14 is a top view of an exemplary embodiment of a base for use with the device in FIG. 1;

FIG. 15 is a perspective view of an exemplary embodiment of a base for use with the device of FIG. 1;

FIG. 16 is a top view of an exemplary embodiment of the present invention having a cross-sectional line AA;

FIG. 17 is a cross section view of an exemplary embodiment of the present invention at line AA;

FIG. 18 is a diagram depicting an exemplary method of using the inventive device;

FIG. 19 is a block diagram representing an exemplary circuit diagram of the present invention.

### DETAILED DESCRIPTION OF THE EXEMPLARY EMBODIMENT(S)

Exemplary embodiments of the present invention will now be described in greater detail. It should be recognized that the present invention can be practiced in a wide range of other embodiments besides those explicitly described, and the scope of the exemplary embodiments described are expressly not limited.

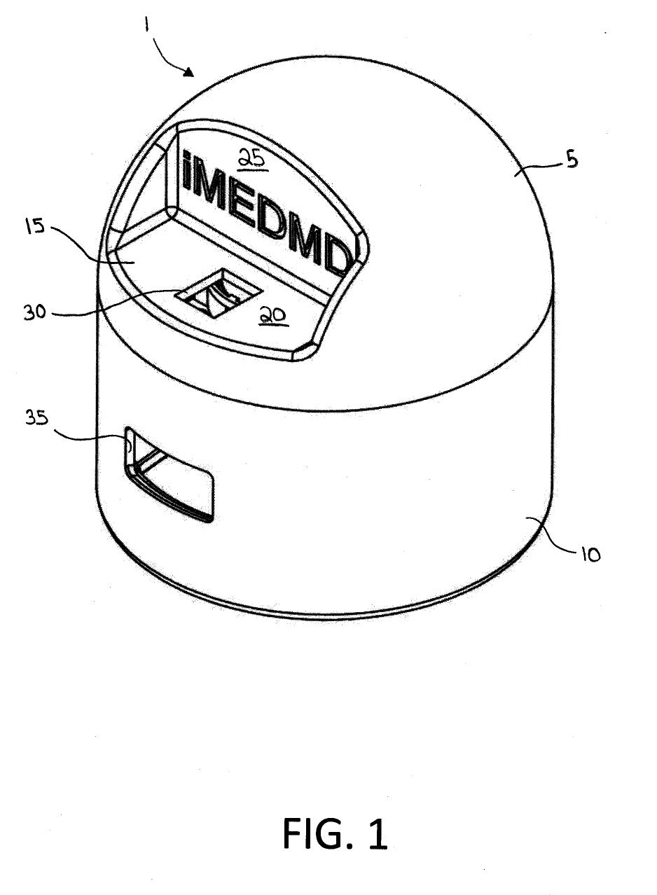

Directing attention to FIG. 1, an exemplary embodiment of the medical dispensing device 1 according to the present invention is shown. The device 1 includes a top lid 5 and a base 10. The top lid 5 has a dome design having an indent 15 therein. The indent 15, formed by the top lid 5, includes a bottom surface 20 and a sidewall 25. As shown, the bottom surface 20 and the sidewall 25 are arranged at approximately 90° relative to each other; however, it should be understood by those skilled that the angle between the bottom surface 20 and the sidewall 25 could be greater than 90° to allow for a greater visual range.

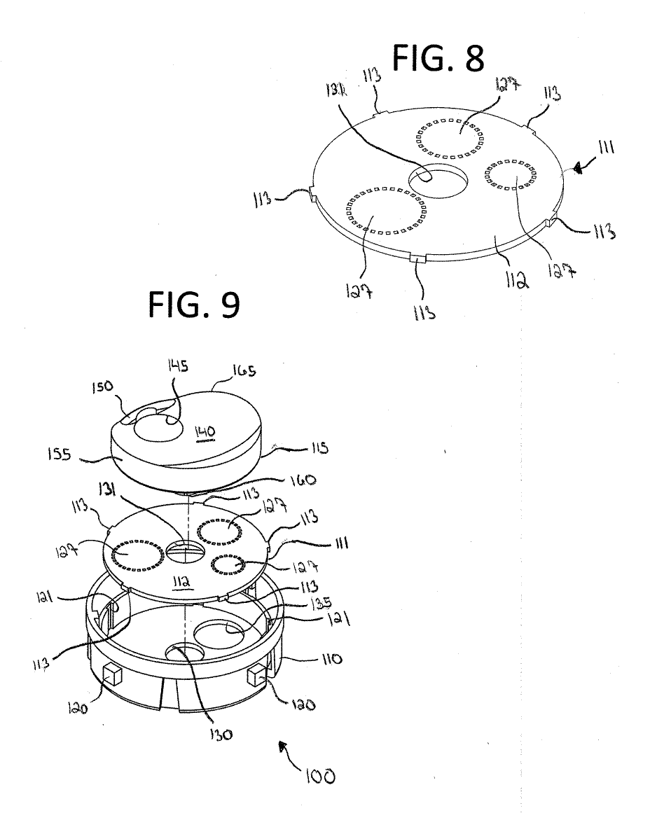

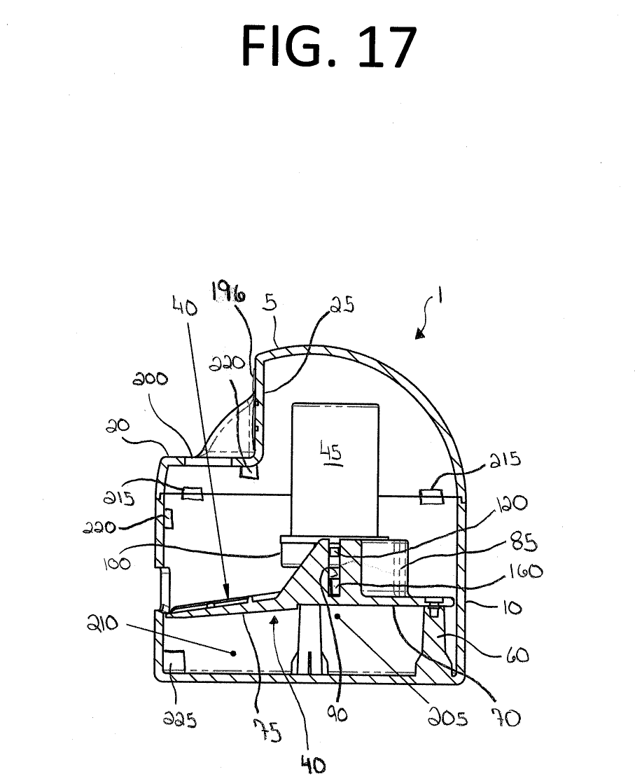

The bottom surface 20 defines an opening 30 therein. The opening 30 allows for the placement of a biometric sensor 200 (shown in FIG. 8) or other similar device. The biometric sensor 200 is used to ensure that only the patient or other approved individual has access to the medication contained within the device 1. The sidewall 25 may be inscribed with a logo or other information, or the sidewall 25 may include a visual screen 196 (shown in FIG. 17) on which to present the patient with medication information or warnings, it could also provide the patient with alerts or other notifications.

The base 10 of the device 1 is a hollow cylinder having a dispensing port 35 therein. The dispensing port 35 is sized and shaped to allow a variety of medications to exit the device 1 unobstructed. However, the dispensing port 35 should not be sized such that a patient or an unintended user may be able to access the medication stored therein through the port without first following the dispensing protocols described elsewhere herein. The top lid 5 and the base 10 are designed to join together to have a secure fit. One of ordinary skill in the art will understand that this joining of the top lid 5 and base 10 may be accomplished in a variety of ways, including interlocking features. Monitored and secure locks 215 (shown in FIG. 9) are also provided to ensure that a patient or other unintended user will be unable to access the medication stored within the device 1.

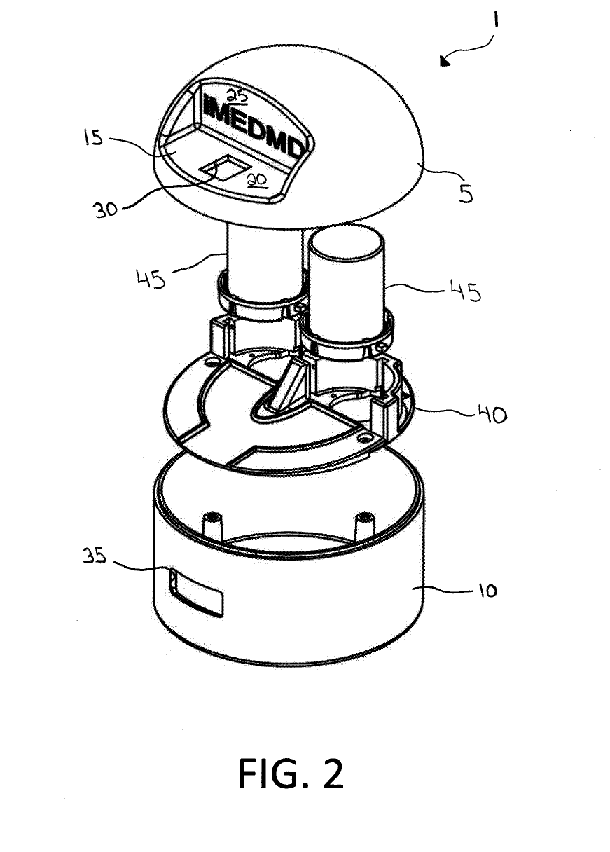

FIG. 2 is an exploded view of the non-electronic components of the inventive device 1 to illustrate their arrangement with the device 1. As shown, a dispensing plate 40 receives standard prescription bottles 45 having an inventive cap 100 thereon. The dispensing plate 40 is secured to the base 10. The prescription bottles 45 are vertically inverted so that the openings of the prescription bottles are in a downward position. Once the prescription bottles 45 have been placed in the dispensing plate 40, the top lid 5 is then placed on the base 10 and locked into place.

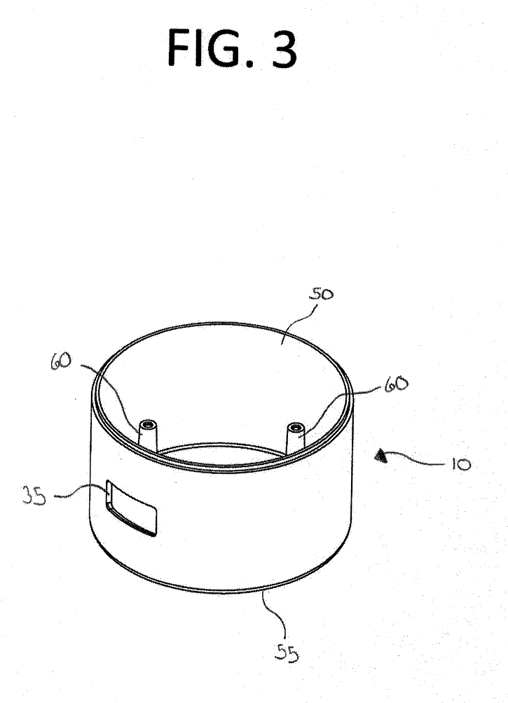

As illustrated in FIG. 3, the base 10 is an open, hollow cylinder having a wall 50 and an end cap 55 forming both the exterior and the interior of the base 10. As discussed previously, the wall 50 has a dispensing opening 35 therein to allow dispensed medication to exit the device 1. In the interior of the base 10, a plurality of supports 60 are provided to allow the dispensing plate 40 to be secured to the base 10. The supports 60 extend from the end cap 55, and are of a sufficient length to allow for the placement of electronic motors and other electronic components under the dispensing plate 40 when attached to the base 10. The dispensing plate 40 is attached to the supports 60 by mechanical fasteners, adhesives, or other methods of attachment known in the art.

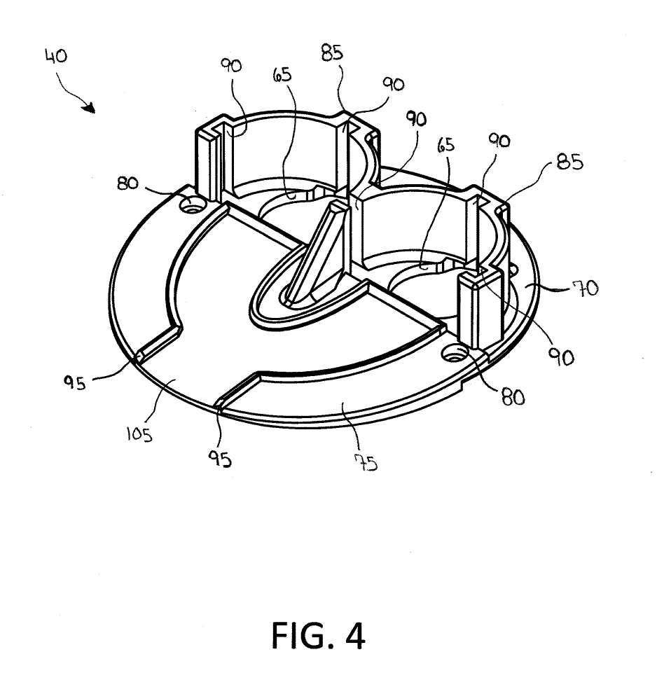

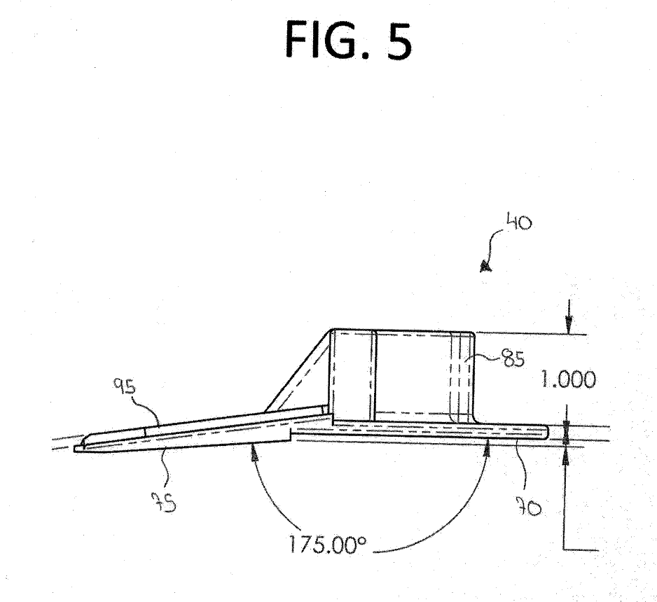

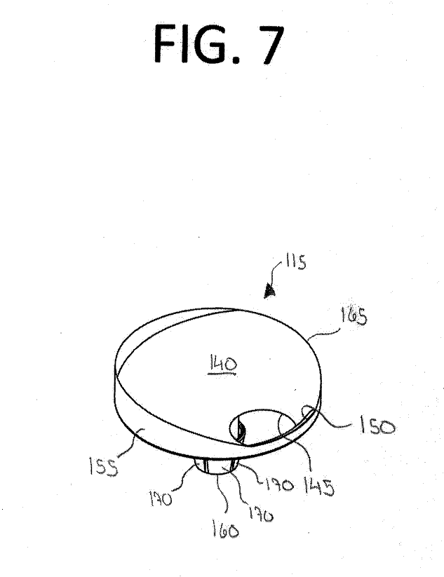

The dispensing plate 40 of the inventive device 1 is shown in FIGS. 4 and 5. As shown, the dispensing plate 40 includes a flat retention portion 70 and an angled dispensing portion 75. The plate 40 also has a plurality of attachment openings 80 therein to allow attachment of the plate 40 to the supports 60 of the base 10. The dispensing plate 40 has retention guides 85 extending therefrom. The retention guides 85 have a crescent shape in order to accommodate and receive the circular inventive caps 100 on prescription bottles 45. Although two retention guides 85 are shown, it should be understood that a different number of retention guides 85 may be used in the device 1. In this manner, the device 1 may accommodate a variety of different medications. The retention guides 85 have a number of retention channels 90 therein. The retention channels 90 are adapted to receive the guide projections 120 on the inventive cap 100 to retain the prescription bottle in the retention guides 85 and to prevent rotation of the cap 100. As shown in FIG. 2, the prescription bottles 45 are placed cap 100 first into the retention guides 85. Access ports 65 are also provided in the dispensing plate 40. The access ports 65 allow for the electric motor 205 (shown in FIG. 9) to contact the pin 160 (shown in FIG. 7) of the inventive cap 100 in order to dispense medication.

As shown in FIG. 5, the angled dispensing portion 75 is angled downward relative to the plane of the retention portion 70. This allows gravity to move medication exiting the prescription bottle 45 toward the dispensing opening 35. As shown in FIG. 4, dispensing rails 95 are provided on the surface of the angled dispensing portion 75. The rails 95 form a dispensing channel 105 to further guide the dispensed medication to the dispensing opening 35.

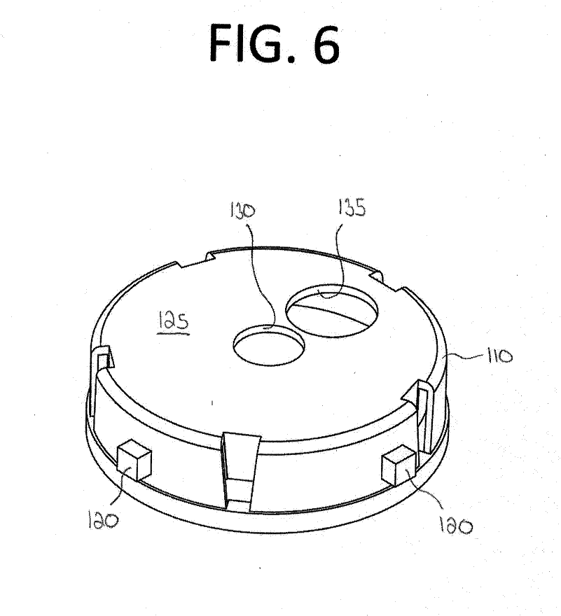

The components of the inventive cap 100 are illustrated in FIGS. 6, 7, and 8. As shown in the figures, the cap 100 includes an outer cap 110, a dispensing insert 115, and an optional size selection insert 111. The outer cap 110 is shaped similar to a traditional prescription bottle cap; however, the outer cap 110 includes a series of guide projections 120 extending horizontally from the outer cap 110. As discussed earlier the guide projections 120, are inserted into the retention channels 90 (shown in FIG. 4) to securely retain the prescription bottle 45 to the dispensing plate 40 and to prevent rotational motion between the outer cap 110 and the dispensing plate 40. The top portion 125 of the outer cap 110 defines a retention opening 130 and a first dispensing port 135.

The dispensing insert 115 of the cap 100 is shown in FIG. 7. The dispensing insert includes a circular body 155 having a concave face 140 and a second dispensing port 145. The concave face 140 allows gravity to direct the medication in the prescription bottle 45 toward and through the second dispensing port 145. An extended lip 150 is provided along the portion of the rim 165 closest to the second dispensing port 145 to direct the medication to the second dispensing port 145. A pin 160 extends from the circular body 155 opposite the concave face 140, and allows for rotatable connection to the outer cap 110. The pin 160 has wings 170 that allow for a secure connection between the outer cap 110 and the dispensing insert 115. To form the inventive cap 100, the pin 160 is inserted into the retention opening 130 in the outer cap 110. The wings 170 are compressed during insertion of the pin 160 into the retention opening 130. Once the wings 170 have passed through the retention opening 130, the wings 170 return to their original uncompressed position preventing the dispensing insert 115 from being removed from the outer cap 110.

To increase the accuracy of the device, an optimal size selection insert 111 may be used. The optional size selection insert 111 is interposed between the outer cap 110 and the dispensing insert 110. The size selection insert 111 is designed to be retained within the outer cap 110, and has a substantially circular body 112. The body 112 is a thin molded piece that may be made from plastic, polymers, or other suitable material. The body 112 defines a retention opening 131 therein. The retention opening 131 allows the pin 160 of the dispensing insert 115 to pass there through. A plurality of retention tabs 113 are arranged along the circumference of the circular body 112. The retention tabs 113 are adapted to fit within the channels 121 in the outer cap 110. Once the tabs 113 are inserted into the channels 121, the size selection insert 111 is prevented from rotating relative to the outer cap 110.

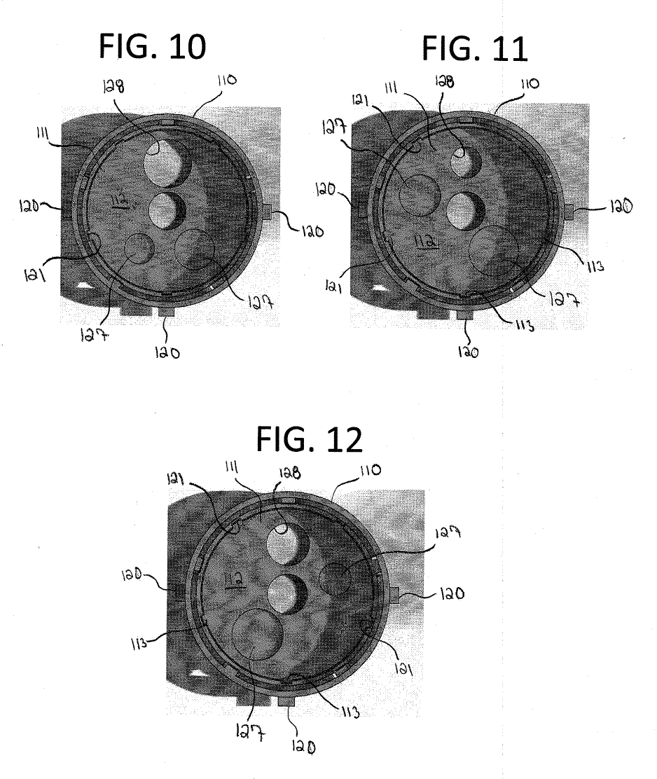

The circular body 112 also includes a plurality of punch-outs 127. The punch-outs 127 may be molded or scored during the manufacturing process or after, in such a manner that allows an individual punch-out 127 to be removed resulting in a sized dispensing port 128 (shown in FIGS. 10-12). As shown, the punch-outs 127 are arranged on the circular body 112, and have different diameters such that when the size selection insert 111 is placed in the outer cap 110 differently sized punch-outs 127 may be aligned with the first dispensing port 135 in the outer cap 110. In this manner, a desired diameter for the sized dispensing port 128 may be selected to correspond to the size of the medication to be dispensed. By allowing for size restriction, the likelihood of dispensing an incorrect amount of medication is reduced. It should be understood by those skilled in the art that the punch-outs 127 and resulting sized dispensing ports 128 may have different sizes and shapes to accommodate different shaped medication.

FIG. 9 is an exploded view of the inventive cap 100 with the optional size selection insert 111. As shown, the size selection insert 111 is rotated so that the tabs 113 can be inserted into the channels 121, and the desired punch-out 127 is aligned with the first dispensing port 135. After the desired punch-out 127 is removed resulting in the desired sized dispensing port 128, the insert 111 may be lowered into the outer cap 115. Then the dispensing insert 115 is then positioned so that the pin 160 is aligned with the retention openings 130, 131 in both the insert 111 and outer cap 110. The pin 160 is then passed through the retention openings 130, 131 so that the outer cap 110, dispensing insert 115, and the size selection insert 111 are retained together forming the inventive cap 100. The cap 100 may then be placed on a prescription bottle 45 to be used with the inventive device 1.

Bottom views of the size selection insert 111 placed in the outer cap 110 are shown in FIGS. 10-12. As illustrated in FIGS. 10-12, sized dispensing ports 128 of the size selection insert 111 having different diameters may be aligned with the first dispensing insert 135 of the outer cap 110. By providing a way to decrease the opening through which the medication is dispensed, the device 1 ensures that the proper amount of medication is dispensed.

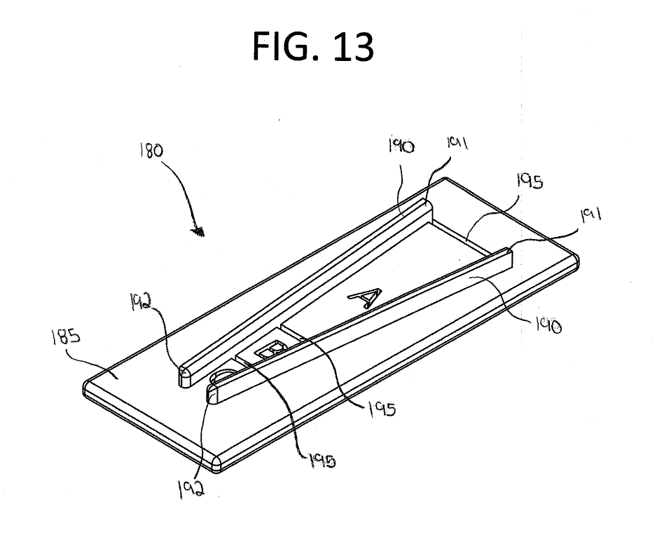

In order to determine the proper diameter punch-out 127 to remove, the system described herein includes a pill measuring device 180 as illustrated in FIG. 13. The measuring device 180 includes a base 185 having guides 190. Further the guides 190 have first ends 191 and second ends 192. The distance between the guides 190 at the first ends 191 is greater than the distance between the guides 190 at the second ends 192 to create a tapered configuration. The measuring device 180 also includes indicator lines 195 positioned at between the two guides 190. The tapered configuration of the guides 190 in conjunction with the lines 195 allows the appropriate punch-out 127 to be selected. Specifically, a pill to be measured may be placed on the base 185 between the guides 190 at the first ends 191. The pill is then moved toward the second ends 192 of the guides 190 until the pill is in communication with both guides 190. Then depending on what lines 195 the pill is between when contacting both guides 190 corresponds to an appropriately sized punch-out 127.

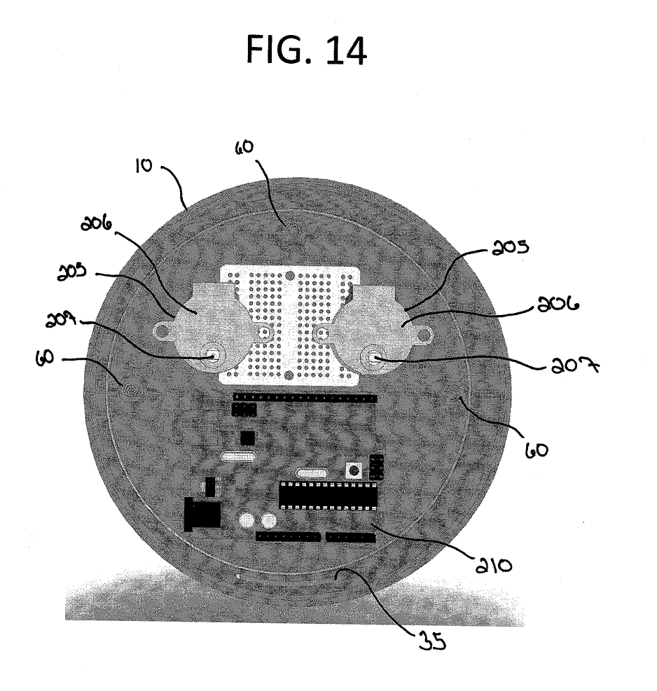

FIG. 14 is a top view of the base 10, without the dispensing plate 40 in order to view several electronic components of the device 1. As shown, the device 1 includes a control circuit 210 located in the bottom of the base 10. The control circuit 210 is a printed circuit board or other similar device having onboard memory. The control circuit 210 is in electronic communication with electric motors 205 positioned in the bottom of the base 10. The electronic motors 205 have a plate 206 to facilitate connection to the dispensing plate 40. The electronic motors 205 each have a post 207 in which the associated electronic motor 205 imparts rotational motion so that the posts 207 spin. The electronic motors 205 are arranged in the base 10 so that the posts 207 contact and are inserted into the pins 160 on the caps 100. In this manner, the rotational motion of the posts 207 is then conveyed to the pins 160 allowing the cap 100 to dispense medication.

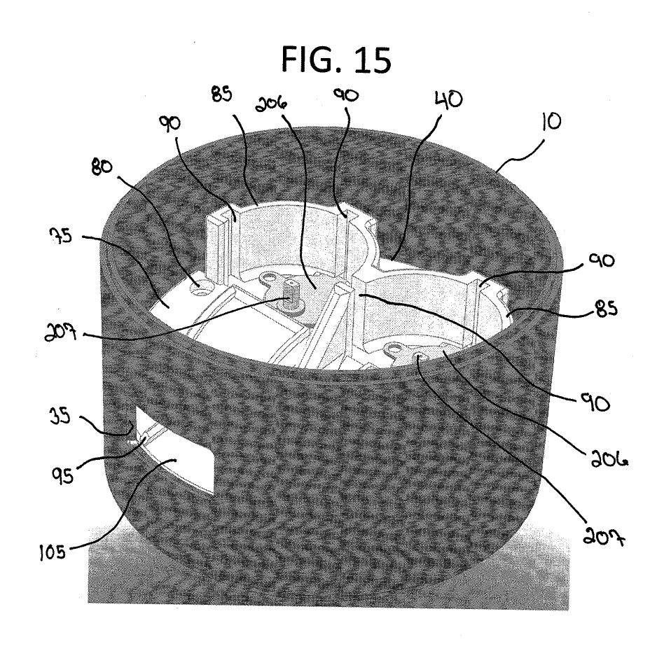

A top perspective view of the base 10 is illustrated in FIG. 15. Of particular importance is the placement of the electric motors 205 (shown in FIG. 14) relative to the dispensing plate 40. As shown, plates 206 of the electric motors 205 sit atop the dispensing plate 45, specifically the retention portion 70. A portion of the plate 206 is retained under the retention guide 85. Additionally, the plate 206 may be affixed to the retention portion 70 by mechanical fasteners, adhesives, or other similar devices or materials. The posts 207, connected to the electric motors 205, extend upward through the plate 206. The posts 207 are adapted to be inserted into the pins 160 on the caps 100. When the electric motor 205 rotates the attached post 207, the post 207 in turn rotates the dispensing insert 115 to dispense medication from the prescription bottles 45.

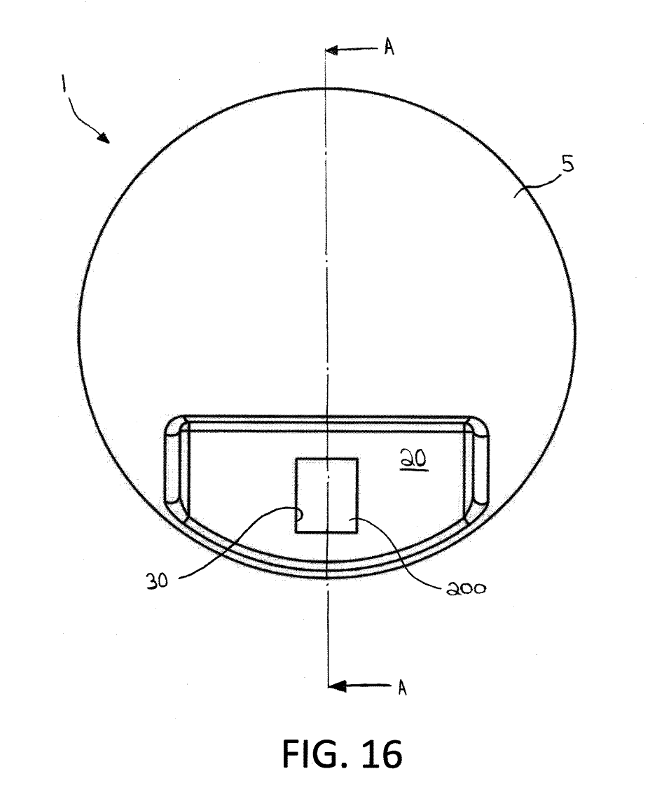

Additional electrical and tamperproof features will now be described with respect to FIGS. 16-17. As discussed elsewhere herein, the device 1 may include a biometric sensor 200 located in the bottom surface 20 of the lid 5 and accessed through the opening 30 in the bottom surface 20. The biometric sensor 200 is a fingerprint recognition sensor able to distinguish the fingerprint of the patient or other approved individual from unauthorized individuals. Although fingerprint recognition is contemplated, other types of biometric analysis may be used to identify the patient. Furthermore, the biometric sensor 200 may detect the presence of alcohol in the patient's secretions in order to prevent a patient from accessing medication that might be harmful to take with alcohol.

In the cross-sectional view in FIG. 17, other electronic components of the present invention are shown. As illustrated, at least one electric motor 205 is located under the dispensing plate 40. The electric motor 205 is positioned within the device 1 to contact the pin 160 on the cap 100 and impart rotational motion. The control circuit 210 is also located under the dispensing plate 40, and in electronic communication with the electric motor 205. The control circuit 210 includes onboard memory 225.

Locks 215 are also provided inside the device 1. The locks 215 are in electronic communication with the control circuit 210 and are used to ensure that a patient or other unauthorized user cannot open the device 1. The locks 215 are placed so that they retain the lid 5 to the base 10. The locks 215 may be unlocked by an authorized individual to insert and remove the prescription bottles 45. Sensors 220 may also be provided in the interior of the device 1. The sensors 220 are in electronic communication with the control circuit 210. The sensors 220 are used to monitor the dispensing of the medication, including the number of pills dispensed, and to monitor for breaches of the exterior of the device 1. The positioning of the sensors 220 in FIG. 17 is exemplary and one skilled in the art should appreciate that the location may be changed to best accomplish monitoring the interior of the device 1. Although the sensors 220 contemplated herein utilize lasers, it should be understood that other types of known sensors in the art may be utilized in the device 1.

The sidewall 25 may also include a visual screen 196. The visual screen 196 is in electronic communication with the control circuit 205. The visual screen 196 may be used to communicate messages to the patient or other authorized users of the device 1. These messages may include alerts, warnings, and medication schedule information.

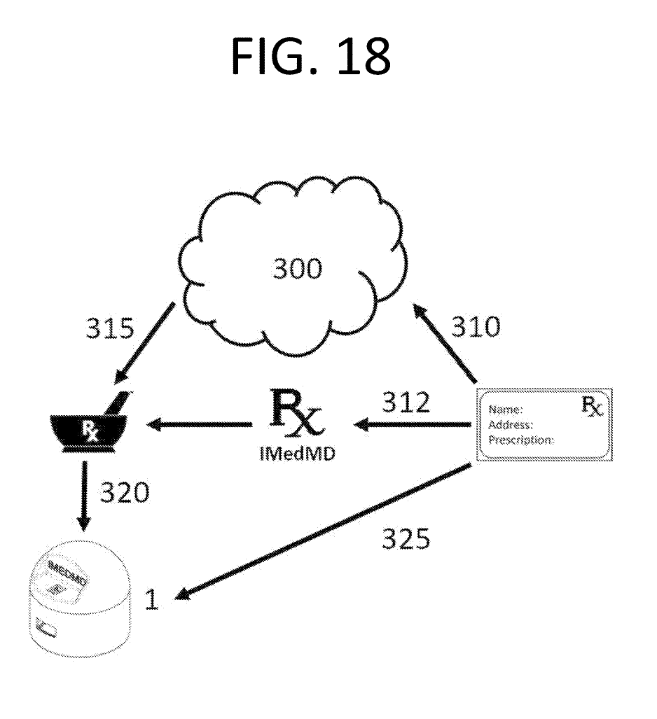

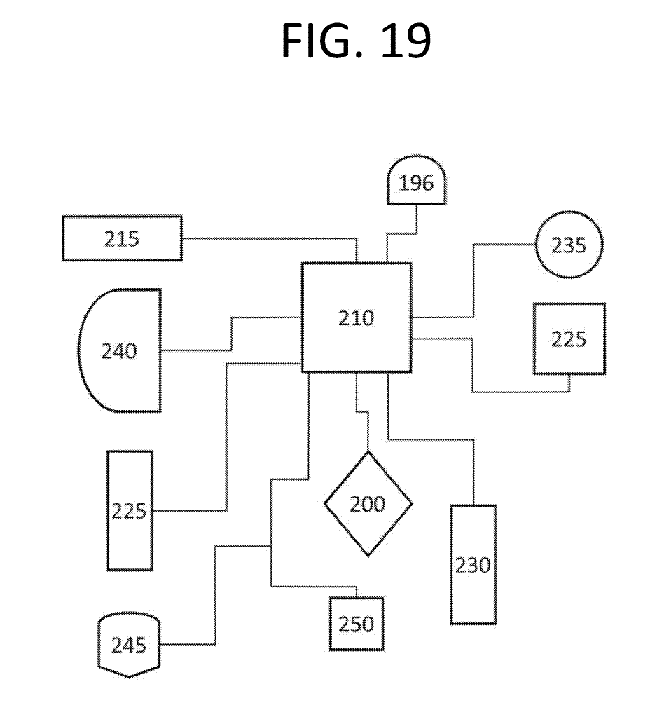

The process of utilizing the inventive device 1 will now be discussed with respect to FIGS. 18 and 19. A cloud system 300 is provided. The cloud system includes a hosted program with associated database that is accessible by authorized users (medical professionals). A prescribing medical professional can upload 310 the patient's information (including biometric scans) and the prescription information to the cloud 300. The biometric information, such as fingerprint, may be obtained from a separate scanner or the biometric scanner 200 in the device may be used. The patient's fingerprint could then be stored locally in the memory 225 of the device 1, or the device 1 could be used to upload the patient's fingerprint to the cloud 300.

The patient's written or electronic prescription would also include that the prescribing medical professional required the inventive device 1 to be used. The patient could then take the prescription to a pharmacy to be filled, or have the prescription electronically sent to a pharmacy 312. The pharmacist would then fill the prescription as normal, using a traditional prescription bottle 45. The pharmacist would then place the inventive cap 100 on the prescription bottle 45. The pharmacist would then load the prescription bottles into the device 1. The pharmacist would then retrieve the information 315 stored on the cloud 300 by the prescribing medical professional and load 320 that information to the device 1. Optionally, if information was stored on the device 1 the pharmacist would not need to download the patient's information from the cloud 300.

This information includes the biometrics of the patient and the prescription schedule. The pharmacist would then check the identity of the patient using the biometric information stored on the cloud or stored in the device's memory 225. If the biometrics of the person picking up the prescription matched the stored biometrics uploaded by the prescribing medical professional, then the patient would receive the device 1 with medication contained therein. However, should the biometrics not match, the individual would not receive the prescription. Optionally, if the patient has a caregiver the, the caregiver may have a biometric scan performed and the device 1 programmed to allow either the patient or the patient's caregiver to access the medication in the device 1.

As discussed herein, the device 1 includes a control circuit 210. The control circuit is electronically coupled to a memory 225. The memory 225 stores the patient's prescription schedule for the medication stored in the device 1, and stores the patient's biometric information, including patient's fingerprint. Optionally, the patient's caregiver biometrics may also be stored in the memory 225. The prescription schedule stored in the memory 225 may include the amount of medication to be dispensed within a predetermined amount of time. Since the prescription schedule is stored in the memory, the device 1 is capable of notifying the patient when it is time to take the medication by a visual and audible alarm. Any visual notification may be transmitted from the control circuit 210 to the visual screen 196. Any audible notification may be transmitted from the control circuit 210 to speakers 250 or other audible devices in electronic communication with the control circuit 210. The speakers 250 may be located at any point in the interior or exterior of the device 1. Additionally, the patient or caregiver may download an application for mobile devices, such as cell phones and tablets, or standard computers. Since the patient's medication schedule is saved in the cloud, the patient or caregiver may receive a notification through the application. The device 1 also has a communication module 235 that may also be able to push notifications to the patient's or the caregiver's mobile devices or computers, either through the application or directly to the device.

If the patient desires to take the medication, the patient or authorized caregiver simply places a finger on the biometric sensor 200, if the scanned fingerprint of the individual attempting to access the medication matches the fingerprint stored in the memory 225, then the individual passed a first check. The control circuit 210 then checks a timing circuit 230 to ensure that the request for medication falls within the predetermined time allowed by the prescription stored in memory 225, this step represents the second check. If both checks are passed, then the medication may be dispensed.

If either the first or second checks fail, then the medication in the device 1 is not dispensed. Additionally, the attempted access to the medication by the individual is stored into the memory and the device 1 would communicate the attempted access to the cloud 300 through a communication module 235 in electronic connection to the control circuit 210. The communication module 235 may have the ability to communicate through cellular signals, wi-fi, radio, and/or Bluetooth. The communication module 235 may communicate the attempted access directly to the cloud 300 and the prescribing medical professional and/or the pharmacist that filled the prescription.

If the first and second checks are passed, the medication is dispensed. To dispense the medication, the control circuit 210 directs a signal to at least one electric motor 205 in electronic communication. Once the electric motor 205 receives the command to dispense the medication in the device 1, it rotates the dispensing insert 115 by way of a pin 160. The electronic motor 205 rotates the dispensing insert 115 so that the first dispensing port 135 is aligned with the second dispensing port 145 to allow a desired amount of medication to fall from the inventive cap 100. The dispensing channel 105 then guides the medication to the dispensing opening 35 for delivery to the patient. The sensors 220 being notified that the dispensing protocol has been activated monitors the amount of medication delivered to the patient. This information as well as the time the medication was delivered to the patient is stored in the memory 225, and may be upload to the cloud 300 for retrieval by the medical professional or pharmacist. If an improper amount of medication is dispensed by the device 1. The device 1 logs the event and may upload the event to the cloud 300. The device 1 may also notify the medical professional and/or pharmacist as well as the patient or approved caregiver.

The device 1, further includes tamper resistant features controlled by the control circuit 210. The sensors 220, electronically coupled to the control circuit 210, also monitor the device 1 to detect an unauthorized breach. To accomplish this, the sensors 220 may be designed to detect motion within the device 1. Once motion is detected outside of the time required to dispense medication, the sensors 220 may send a signal to the control circuit 210. The control circuit 210 would then activate the appropriate protocol in an attempt to prevent the unauthorized access to the medication in the device. Additionally, the locks 215 being in electronic communication with the control circuit may also be used to detect an attempted unauthorized access to the medication in the device 1. As with the sensors 220, once the locks 215 detect that unauthorized access is being attempted, a signal would be sent to the control circuit 210, which would begin the appropriate protocol. Once tampering protocol has been initiated, the device 1 has features to attempt to prevent further access to the medication therein. First, the device 1 includes a spray mechanism 245 in communication with the control circuit 210. If tampering is detected the control circuit 210 directs the spray mechanism 245 to direct a chemical to the medication to render the medication inactive.

Along with the ability to prevent unauthorized access to the medication in the device 1, the device 1 also allows the prescribing medical professional and/or pharmacist to monitor the patient's usage. As provided, the memory 225 stores all events such as proper dispensing, attempted access either outside the predetermined timing window or by an unauthorized user, or tampering. The memory then uploads to the cloud using communication module 235. The medical professional or pharmacist may then access this information stored on the cloud. The device 1 may also use the communication module 235 to contact the medical professional and/or pharmacist directly.

The device 1 also allows for the collection of patient data. The patient may input information such as, pain information, medication reaction, etc. This information may be input into the application then uploaded directly to the cloud 300 or communicated to the device 1 and stored in the memory 225. The medical professional could then use this information for a variety of purposes including medication adjustment, prescription timing adjustments, etc.

The use of the inventive device 1 also allows medical professionals to make changes to the patient's prescription. If the medical professional wishes to change the patient's prescription, including changing the amount of medication or the timing of the dosages, the medical professional may simply log into the cloud 300 access the patient's prescription information and make a change to the prescription. The device 1 may then retrieve the new prescription information from the cloud 300 and update the prescription information stored in the memory 225 changing the prescription. The medical professional may also be able to remotely access the device 1 and make any desired prescription changes.

What is claimed is:

1. A medication dispensing device comprising:
a top lid, said top lid having an opening defined therein;
a base, said base having a wall and an end cap;
a dispensing port defined in said wall;
a dispensing plate retained in and attached to said base, said dispensing plate is adapted to receive a prescription bottle having a cap; and
a biometric sensor attached to said top lid in said opening.

2. The medication dispensing device of claim 1, wherein said dispensing plate further comprises:
a retention portion;
an angled dispensing portion; and
at least one retention guide extending from said retention portion, said retention guide having retention channels therein.

3. The medication dispensing device of claim 1, wherein said cap further comprises:
an outer cap, said outer cap defining a retention opening and a first dispensing port;
guide projections extending from said outer cap; and
a dispensing insert having a concave face with a second dispensing port therein, and a pin extending from said dispensing port opposite said concave face,
wherein said pin is inserted through said retention opening and allows said dispensing insert to be rotatably attached to said outer cap.

4. The medication dispensing device of claim 1, wherein said cap further comprises:
an outer cap, said outer cap including:
a retention opening defined therein;
a first dispensing port defined therein;
guide projections extending from said outer cap;
a dispensing insert, said dispensing insert including:
a concave face;
a second dispensing port;
a pin extending from said dispensing port opposite said concave face;
a size selection insert interposed between said outer cap and said dispensing insert, and adapted to be retained within said outer cap, said size selection insert includes:
punch-outs; and
a retention opening defined therein;
wherein said pin is inserted through said retention openings in both the outer cap and the size selection insert and allows said dispensing insert to be rotatably attached to said outer cap.

5. The medication dispensing device of claim 4, further comprising:
a size selection insert interposed between said outer cap and said dispensing insert, wherein said size selection insert has punch-outs that when removed create a sized dispensing port in said size selection insert.

6. The medication dispensing device of claim 1, further comprising:
an electric motor, said electric motor in communication with said cap to dispense medication; and
a control circuit in electronic communication with said electric motor.

7. The medication dispensing device of claim 6, further comprising:
locks in electronic communication with said control circuit, said locks adapted to securely retain said top lid to said base.

8. The medication dispensing device of claim 6, further comprising:
sensors in electronic communication with said control circuit, said sensors positioned within said top lid.

9. The medication dispensing device of claim 6, further comprising:
a visual screen in electronic communication with said control circuit, said visual screen located in said top lid.

10. The medication dispensing device of claim 6, further comprising:
a speaker in electronic communication with said control circuit, said speaker providing audible alerts to a user.

11. A medication dispensing device comprising:
a top lid, said top lid having a domed shape, and further includes:
an indent therein having a bottom surface and a sidewall;
an opening defined by said bottom surface;
a cylindrical base, said base having a wall and an end cap, said base further includes:
supports extending from the end cap of said base;
a dispensing opening defined by said wall, said dispensing opening allows dispensed medication to exit the medication dispensing device;
a dispensing plate, having a retention portion and a dispensing portion, said dispensing plate further included:
retention guides extending from said retention portion, said retention guides have a crescent shape and retention guides therein;
access ports defined by the retention portion,
wherein said dispensing portion is angled downward relative to said retention portion and said dispensing portion directs medication toward said dispensing opening in said base;
a cap, said cap having an outer cap and a dispensing insert and placed on a prescription bottle, said cap further comprising:
guide projections extending from said outer cap, said guide projections are adapted for insertion into guide channels to prevent rotational motion between said outer cap and said retention guides;
a retention opening defined by said outer cap;
a first dispensing port defined by said outer cap;
a dispensing insert having a concave face and a second dispensing port;
a pin extending from said dispensing insert opposite said concave face, wherein said dispensing insert is attached to said outer cap by inserting the pin through said retention opening allowing said dispensing insert to rotate relative to the outer cap;
a control circuit located in said base, said control circuit having a memory;
an electric motor located in said base in electronic communication with said control circuit, said electric motor includes:
a plate for securing said electric motor to said dispensing plate;
a post extending from said electric motor and in communication with said pin, wherein said electric motor rotates the post which in turn rotates said pin in order to rotate the dispensing insert such that the first and second dispensing ports may be aligned in order to allow medication to be dispensed from said prescription bottle; and
a biometric scanner in electronic communication with said control circuit, said biometric scanner located in said opening in said top lid.

12. The medication dispensing device of claim 11, further comprising a size selection insert, said size selection insert further includes:
a plurality of pre-scored punch-outs, wherein when a punch-out is removed a sized dispensing port is created in said size selection insert; and
a retention opening defined by said size selection insert, wherein said size selection insert is retained in said outer cap.

13. The medication dispensing device of claim 12, further comprising:
locks in electronic communication with said control circuit, said locks adapted to securely retain said top lid to said base;
a visual screen in electronic communication with said control circuit, said visual screen located in said top lid; and
a speaker in electronic communication with said control circuit, said speaker providing audible alerts to a user.

14. The medication dispensing device of claim 13, wherein said memory is adapted to store a medication schedule for the medication in the device and said control circuit is adapted to operate the electric motors to dispense the desired amount of medication at a desired time.

15. The medication dispensing device of claim 14, wherein said memory is adapted to store an authorized user's fingerprint and said control circuit is adapted to compare the stored fingerprint to a fingerprint input from said biometric scanner.

16. The medication dispensing device of claim 15, further comprising a communication circuit in electronic communication with said control circuit, wherein said communication circuit allows the device to wirelessly communicate with computer program, mobile application, or cellphone.

17. A medication dispensing device comprising:
a top lid, said top lid having a domed shape, and further includes:
an indent therein having a bottom surface and a sidewall;
an opening defined by said bottom surface;
a cylindrical base, said base having a wall and an end cap, said base further includes:
supports extending from the end cap of said base;
a dispensing opening defined by said wall, said dispensing opening allows dispensed medication to exit the medication dispensing device, wherein said base is capable of being securely fastened to said top lid;
a dispensing plate, having a retention portion and a dispensing portion, said dispensing plate further included:
retention guides extending from said retention portion, said retention guides have a crescent shape and retention guides therein;
access ports defined by the retention portion;
dispensing rails forming a dispensing channel on said dispensing portion, wherein said dispensing portion is angled downward relative to said retention portion and said dispensing channel directs medication toward said dispensing opening in said base
a cap, said cap having an outer cap and a dispensing insert and placed on a prescription bottle, said cap further comprising:
guide projections extending from said outer cap, said guide projections are adapted for insertion into guide channels to prevent rotational motion between said outer cap and said retention guides;
a retention opening defined by said outer cap;
a first dispensing port defined by said outer cap;
a dispensing insert having a concave face and a second dispensing port;
a pin extending from said dispensing insert opposite said concave face, wherein said dispensing insert is attached to said outer cap by inserting the pin through said retention opening allowing said dispensing insert to rotate relative to the outer cap;
a control circuit located in said base, said control circuit having an associated memory;
an electric motor located in said base in electronic communication with said control circuit, said electric motor includes:
a plate for securing said electric motor to said dispensing plate;
a post extending from said electric motor and in communication with said pin, wherein said electric motor rotates the post which in turn rotates said pin in order to rotate the dispensing insert such that the first and second dispensing ports may be aligned in order to allow medication to be dispensed from said prescription bottle;
a biometric scanner in electronic communication with said control circuit, said biometric scanner located in said opening in said top lid;
locks in electronic communication with said control circuit, said locks securely retaining said top lid to said base;
a visual screen in electronic communication with said control circuit, said visual screen located in said top lid;
a speaker in electronic communication with said control circuit, said speaker providing audible alerts to a user; and
a communication circuit in electronic communication with said control circuit, wherein said communication circuit allows the device to wirelessly communicate with a computer program, a mobile application, or a cellphone.

18. The medication dispensing device of claim 17, further comprising a size selection insert interposed between said outer cap and said dispensing insert, said size selection insert further includes:
a plurality of pre-scored punch-outs, wherein when a punch-out is removed a sized dispensing port is created in said size selection insert;
a retention opening defined by said size selection insert; and
retention tabs around the circumference of said size selection insert, said retention tabs are inserted into channels in said outer cap in order to retain said size selection insert to said outer cap and prevent rotation between said outer cap and the said size selection insert.

19. The medication dispensing device of claim 17, wherein said memory is adapted to store a medication schedule for the medication in the device and said control circuit is adapted to operate the electric motors to dispense the desired amount of medication at a desired time.

20. The medication dispensing device of claim 19, wherein said memory is adapted to store an authorized user's fingerprint and said control circuit is adapted to compare the stored fingerprint to a fingerprint input from said biometric scanner.
